(19) United States
(12) Patent Application Publication
(10) Pub. No.: US 2022/0385756 A1
(43) Pub. Date: Dec. 1, 2022

(54) Special device and system to disable a driver from texting and being distracted during driving

(71) Applicant: Patrick Freeman, Indianapolis, IN (US)

(72) Inventor: Patrick Freeman, Indianapolis, IN (US)

(21) Appl. No.: 17/332,911

(22) Filed: May 27, 2021

(51) Int. Cl. H04M 1/72463; H04W 4/90; H04W 4/14; H04W 48/04; G06F 9/448

(52) U.S. Cl. CPC H04M 1/72463; H04W 4/90; H04W 4/14; H04W 48/04; G06F 9/4484

(57) ABSTRACT

A device and system to disable a driver from texting and being distracted during driving a vehicle, this disable a driver from texting and being distracted by combining a blocking signal component from an ECM of an engine or a discrete electronic blocking device to notify the cellphone application that the vehicle engine is functioning and operation movement is occurring with at least one blocking application that signals the cellphone to block all incoming and outgoing communication signals to a set of temporarily unwanted cellphone applications and functions but still leaving a set of emergency applications working and available for use; the device also has a manner of communicating to the blocked application which are temporarily disabled and way to clear and re-enable the applications when the period is done.

### CROSS-REFERENCE TO RELATED APPLICATIONS

None

### FIELD OF INVENTION

This invention relates to the field of cellular phones and cellular communications technology including text messaging, emailing, and voice communications technology, GPS technology, related computer systems and software, and vehicular transportation modalities. This invention relates to an auxiliary device and system to temporarily disable a driver from texting and being distracted during driving a vehicle. Particularly this device or system is related to products and manners to prevent distraction while driving a vehicle. The subject matter described herein generally relates to restricting services of a communication device. Some implementations of the subject matter relate to selectively disabling services provided by an individual's communication device based on a location of the communication device or other determination that the individual is engaged in an activity for which the distractions of the communication device usage can be dangerous or should otherwise be restricted. The present disclosure relates generally to wireless communications devices and, in particular, to techniques for disabling certain device functionalities based on motion of the device.

This invention further relates in general to improving the safety of drivers as it relates to the use of cellular phones and other portable electronic communication devices. In particular this invention relates to increasing the safety and wellbeing of a cellular phone user if he should be simultaneously driving a vehicle. Specifically, this invention relates to a means for disabling a driver's cellphone so that when a cellphone is in motion, except for specific situations, the availability of the cellphone for communication purposes is curtailed in order to allow the cellphone owner to remain totally focused on the control of the moving vehicle. The disclosure relates to inhibiting all of the functions of a multi-function portable personal communications device and inhibiting one or more functions of a cellular telephone handset when the handset is moved at an average velocity greater than a predetermined value. The inhibited functions generally relate to restricting the use of a mobile communication device by an operator of a vehicle, and in particular, to restricting operator use of mobile services such as texting, watching videos, and playing games while, e.g., driving an automobile.

### FEDERALLY SPONSORED RESEARCH

None.

### SEQUENCE LISTING OR PROGRAM

None.

### BACKGROUND—FIELD OF INVENTION and PRIOR ART

As far as known, there are no device to disable a driver from texting and being distracted during driving a vehicle or the like. It is believed that this product is unique in its design and technologies.

### Background

Cellular phones are the fastest growing form of communication. Wireless communications devices provide a variety of useful functions, such as voice communication, e-mail, and Web browsing. Instant messaging and e-mail are extremely popular applications on these devices. In much of the world the communication norm has shifted away from hard lines to the almost exclusive use of cellular phones. Their portability and convenience of use makes them the ideal replacement for hard-line systems, and cellular phones have become so ubiquitous, that it is not at all uncommon in any reasonably sized metropolis to be left with the impression that much of the world has gone mad and is talking animatedly to themselves as they move about their business.

The same features of portability and convenience that make them so ubiquitous can also in certain circumstances make them a hazard. Specifically, for example, a person indulging in a potentially hazardous exercise such as driving a car at high speeds or in congested areas, or working heavy duty machinery, or flying an airplane while also participating in a cellular telephone conversation, can easily become a danger to himself and others around him. Especially if the telephone conversation is of an important or stressful nature which introduces its own measure of distraction. Consequently, an animated or stressful telephone conversation undertaken while participating in an already distracting activity (driving, flying) that requires the cellphone user's full attention is a sure recipe for disaster.

Of all the possible combinations of cellphone usage coinciding with other distracting activity, the combination involving cellphones and cars is the most-prevalent. Even though commonsense would dictate that the driver pulls the vehicle over to the side of the road to use the cell phone, human behavior being what it is, this is seldom found to be the case. In actuality, the combination is so fraught with danger and has so repeatedly been implicated in accidents, that many corporations that provide their employees cellphones for business use strictly prohibit the use of the cellphone while driving.

Cell phone and other portable communication device usage while driving has been determined through numerous independent studies to significantly impair a vehicle operator's ability to drive or operate vehicles including private vehicles, public transportation, automobiles, and heavy equipment. In fact, some studies have definitively determined that the distraction of sending and receiving text messages, e-mail messages, or the like by a driver while operating a vehicle can be even more dangerous than a driver under the influence of alcohol. In response to this public threat, many governments have recently passed legislation aimed at limiting or even eliminating the use of portable communication devices by drivers while operating vehicles. However, there can be instances in which access to a portable communication device can be a life-saving tool due to the lack of communications infrastructure in times of a vehicle emergency. Therefore, the selective disabling of specific portable communication device capabilities, such as texting, or one or more specified features, while operating a vehicle can be an advantageous method of controlling operator usage and improving safe vehicle operation. Legislative solutions only address the penalty applied to a user when found guilty of the action and do very little to prevent the effects of this extremely dangerous and in some cases even deadly activity.

A telling example of this lost functionality is available from a recent report generated by the University of Utah which demonstrates that motorists between the ages of 18 and 25 talking on the cellphone have their driving acumen deteriorate to that of elderly people. Details of the study can be found in the winter (2005) issue of the journal Human Factors, a quarterly publication of the Human Factors and Ergonomics Society. This lost functionality shows up in the cellphone users slowed reaction time and slowed movements, making them more prone to accidents. David Strayer, a University of Utah psychology professor and principal investigator of the study described the transition as “instant aging”, whereby the reaction times of a 20-year-old using a cellphone while driving mimicked that of a 70-year-old. Because cellphone service providers estimate that 40% or more of their revenues might be generated by. people while driving, they have a financial bias towards discounting such distraction theories. There is even a serious move afoot to create the impression that the hands-free mode of cellular communication is safe and that individuals using such a system are not impaired in their driving skills. Unfortunately, this study debunks that myth. The study clearly demonstrates that whether or not the driver's hands are free, the driver's active participation in a phone conversation is sufficient to impair his/her driving ability.

In a damaging indictment, the study further claims that motorists talking on cellphones acted more impaired than drunken drivers with blood-alcohol levels exceeding 0.08. The studies were conducted using a simulator and only hands-free phones that are considered safer were used. Quantitatively, drivers who talked on cellphones were 18% slower in braking and took 17% longer to return to the speeds they were maintaining before they braked. Given that most sizeable metropolitan areas have lengthy rush hour periods, and any inefficiencies during rush hour can significantly impact the commuting time of millions of other commuters, it is only a question of time before data is available to indicate the significant loss of productivity resulting from the slowed response and lost driving acumen demonstrated by individuals using cellphones while driving.

In the United States, automobile accidents are the leading cause of death for teenagers. For example, in 2005, 4,544 teenagers between the ages of 16 to 19 died of injuries caused by motor vehicle crashes. In the same year, nearly 400,000 motor vehicle occupants in this age group sustained nonfatal injuries that required treatment in an emergency department. A number of risk factors are associated with teenage drivers. Teenage drivers are less experienced and less likely to recognize and appreciate hazardous conditions and are more likely to exceed speed limits. Teenage drivers are also more likely to become distracted while driving. One major cause of distraction is cellular telephone use and, in particular, text messaging while driving. Text messaging has become a favorite mode of communication between teenagers. However, text messaging while driving a vehicle presents a hazard to the vehicle operator, passengers, and other drivers. With the development of Multimedia Messaging Service (MMS) the temptation to use cellular messaging capability while operating a vehicle becomes greater. It has been estimated that up to fifty percent of teenage drivers have formatted, sent and/or read text messages while operating a vehicle.

Several states have, or are considering, prohibiting text messaging while driving. However, enforcing laws prohibiting text messaging may prove problematic since the cellular device may be held in a position where it is not visible to law enforcement personnel. Further, a certain number of teenagers and other drivers may simply ignore the laws, especially if the penalty is nominal. Thus, there exists a need for a method of detecting and inhibiting the use of certain functions of cellular devices such as Short Message Service (SMS), Multi-media Message Service (MMS) and email while the operator of the device is also operating a vehicle.

Some studies have found that just listening on a cell phone while driving is significantly distracting to the human brain and can cause the driver to make driving errors similar to those that can occur while under the influence of alcohol. In fact, in one study at Carnegie-Mellon University, the part of the brain associated with driving had a 37% decrease in brain function while a person was listening to a conversation and trying to understand the topics discussed and formulate response questions. This serious drop in cognitive awareness occurred regardless of whether the test subjects were using hand-held or hands-free mobile devices. As risky and dangerous as cell phone voice use is, the exploding popularity of text messaging (also known as texting) in the past few years, has made texting while driving (TWD) an even greater risk. A recent poll found that over 46% of teenage drivers admitted to texting while driving, with the actual rate probably higher than that. Because texting obviously involves the visual attention of the user's eyes to read a message and type in a message, the degree of distraction is far greater. Local and national news outlets have sadly reported a steady stream of fatal accidents where the cause was texting while driving. As a result, many state legislatures have banned or are discussing bans of TWD. Fourteen states in the U.S. will have TWD bans for all drivers at all times in effect by the end of 2019, with 10 states banning texting for novice (typically teen) drivers. Most states make these primary offenses. Very recent studies show one (1) in eight (8) driving accidents are due to various distractions while one (1) in four (4) are due to texting.

While legislation is a good and necessary step to influence safe driving behavior and reduce accidents, it is not sufficient to prevent, or really restrict, the incidents of distracted and dangerous driving while using a mobile device. Too many people continue to drive dangerously despite existing laws and the known dangers. What is needed is a technical solution to reliably restrict mobile device services in situations that could cause danger to the user or other people. Further, the solution needs to make it difficult to circumvent or break the solution itself. With the type of mobile devices expanding (cell phones, smart phones, Personal Digital Assistants {PDAs}, wireless computers, mobile digital TVs, etc.), and new wireless technologies emerging (cellular, WLAN, WiMAX, Whitespace, mobile DTV, etc.), and the types of mobile services diversifying (voice, text, video, Internet, games, etc.) the need for a technical solution is even greater.

A need exists for a method and system which detects operation of a vehicle, and controls specific services on one or more mobile phones (more generally, “mobile communication devices” or “wireless communication devices”), wherein the use of such services, while driving, can sufficiently distract a driver due to, e.g., the driver viewing and/or composing one or more non-driving related communications via the mobile communication device so that there is a significant decrease in driving safety. In particular, a need exists for a reliable network-based solution that monitors vehicle and mobile device status, and provides information regarding such statuses, along with subscriber service settings, to a network-based service provider to thereby control the services provided by the mobile communication device. Such a network-based method and system can provide advantages over other arrangements which exclusively rely on software in the mobile communication device (which could be compromised) and/or on a wireless Bluetooth connection directly to the device. It is therefore desirable and an object of the invention to provide a way for a user to disable aspects of their mobile devices so that they are not disturbed or tempted by the devices. It is necessary to deploy a solution that can be generally effective without requiring changes to currently deployed user phones, existing cellular hardware infrastructure, or existing vehicles.

### Problem Solved

The improvement and problem solved as to distractions while driving should be readily understood. Saving fractions of a second or even seconds will permit young and old drivers alike to stay focused and concentrate on the driving at hand. Talking on the telephone, exchanging text and email messages and even video chats distract and cause concentration on driving to be diverted. The addiction-like dependence on a cellphone becomes unstoppable by mere will-power or self-control. A physical elimination or block must be put in place for most drivers. Therefore, the device and system to disable a driver from texting and being distracted during driving a vehicle is a useful and needed creation and development to improve the driving situation. It will save accidents, casualties—injuries and even fatalities—as well as property damage.

### Prior Art

In an attempt to solve the risks of TWD—Texting While Driving—a variety of technologies have emerged or been proposed. One such technology, provided by a company Textecution, www.textecution.com, provides an application for Android phones wherein the technology disables the entire texting function when it determines the mobile phone is moving at more than 10 miles per hour (mph), which is based on the GPS (Global Positioning System) capability built-in to the phone. Another technology, identified by the name Key2SafeDriving, http://safedrivingsystems.com, uses a special design key with a casing (also known as a fob) that surrounds the key. When the key is flipped or slid open the fob sends a Bluetooth wireless signal to the phone to disable the entire mobile phone. Similarly, a solution by ObdEdge, http://www.cellcontrol.com, uses a module attached to a vehicle to send a Bluetooth signal directly to a mobile phone indicating that the car is moving, and in turn, software on the phone disables the phone.

A disadvantage of these technologies is that they tend to take an overly broad approach to solving the problems of talking while driving, and/or texting while driving. These technologies are designed to detect motion of the mobile (typically a speed above 5-10 miles per hour), and then typically disable the entire mobile phone. They do not distinguish whether the user of the mobile is in the driver's seat of a vehicle, or in the passenger seat, or the back seat, or a seat on a bus or train. As a result, they typically incorporate an over-ride to allow the user to bypass the blocking feature when they are a passenger. It is obvious that this creates a significant limitation to blocking in that the user can disable the block when they desire to text and drive. That is, such technologies do not have a position detection mechanism, to operate in conjunction with a controller for activating/deactivating service (e.g., texting) provided by a mobile, for determining where a mobile is located within a moving vehicle and then determining whether a service provided by the mobile should be disabled or enabled.

A novelty search shows that no prior art accomplishes what this Device and system to disable a driver from texting and being distracted during driving a vehicle. Prior art includes:
A U.S. Pat. No. 9,661,127 entitled Locking-Out A Driver Handheld Mobile Device During Driving of a Vehicle for Texting and Browsing was issued to Singh in 2017. It teaches a lock-out mechanisms for driver handheld mobile devices are provided to prevent operation of one or more functions of handheld mobile devices by drivers when operating vehicles based on device location data and device motion data within a vehicle by wirelessly communicating with at least one wireless station access point located inside of the vehicle. The lock-out mechanisms disable the ability of a handheld mobile device to perform certain functions, such as texting or browsing, while one is driving. In one embodiment, a handheld mobile device may provide a lock-out mechanism without requiring any modifications or additions to a vehicle by using a motion analyzer, a mobile device position locator and a lock-out mechanism. In other embodiments, the handheld mobile device may provide a lock-out mechanism with modifications or additions to the vehicle, including the use of wireless signals transmitted by the vehicle or by a wireless station access point disposed within the vehicle.
B U.S. Pat. No. 9,462,110 called Methods and Systems for Disabling One Or More Text Messaging Features While Driving was issued to Schlesener et al. in 2016. Portrayed are Methods and systems are provided for disabling text messaging while driving. In one embodiment, a mobile station makes a first determination that it is moving at greater than a threshold rate. The mobile station makes a second determination that, while it is moving at greater than the threshold rate, an outgoing text message reflects more than a threshold degradation in typing proficiency. In response to making the first and second determinations, the mobile station disables one or more text-messaging features.
C U.S. Pat. No. 9,386,447 called Method and System for Controlling A Mobile Communication Device was issued to Tiddbits et al. in 2016. Disclosed herein is a method and system for detecting, monitoring and/or controlling one or more of mobile services for a mobile communication device (also referred to herein as a Controllable Mobile Device or CMD), and in particular, when the device is being used and the vehicle, operated by the user of the device, is moving. The present method and system determine whether the vehicle is being operated by a user that may also have access to a mobile communication device which, if used concurrently while the vehicle is in operation, may lead to unsafe operation of the vehicle. If the mobile services control system determines that a vehicle operator has potentially unsafe access to a mobile communication device, the mobile services control system may restrict operator access to one or more services that would otherwise be available to the operator via the mobile communication device.
D U.S. Pat. No. 8,892,084 named a Deactivation System and Method for A Transferrable Device was issued to Jung et al. in 2014. It teaches Methods and systems for deactivation of one or more applications operating on a transferable device are provided.
E U.S. Pat. No. 8,417,268 entitled Methods and Systems for Disabling Text Messaging was issued to Halferty et al. in 2013. It describes methods and systems are provided for disabling text-entry capabilities. In one embodiment, a mobile station detects that it is being supported by a given single hand of a user and not by two hands of the user. The mobile station also detects that it is being operated by the single given hand of the user and not by two hands of the user. Optionally, the mobile station also determines that it is moving at greater than a threshold rate or detects more than a threshold degradation in text-entry proficiency. In response to detecting at least that the mobile station is being supported and operated by the single given hand of the user and not by two hands of the user, the mobile station disables one or more text-entry capabilities.
F U.S. Pat. No. 8,380,176 called a System for Preventing Text Messaging While Driving was issued to Adler et al. in 2013. Taught here is a method of inhibiting a function of a multi-function portable personal communications device includes determining a first position of the personal communications device, after a predetermined time interval, determining a second position of the personal communications device, determining the distance between the first position and the second position, determining the time interval in which the personal communications device moved from the first position and the second position, calculating an average velocity of the personal communications device based on the first position, the second position and the time interval and, if the average velocity of the personal communication device exceeds a predetermined value, inhibiting a function of the personal communications device.
G U.S. Pat. No. 8,295,854 entitled System for Preventing Text Messaging While Driving was issued to Osann Jr. in 2012. It is a system and method are described to disable texting while driving a moving vehicle. The position and speed of a user's cell phone are compared with that of a registered master phone. If the position and speed track that of the master phone, it is assumed that the user is a passenger and not a driver, and texting is enabled for that user. Texting at speed is disabled for a master phone user who may be an ordinary citizen or may be a professional driver of a mass transit vehicle. The user of a master phone may utilize a different service provider than a passenger. Information parameter measurements such as cell phone position, velocity, and direction of travel are time stamped and then passed between service providers or alternately made available to other service providers by way of a central database.
H U.S. Pat. No. 8,217,800 called a Motion Based Disabling of Messaging on A Wireless Communications Device was issued to Vander Veen et al. in 2012. It describes when a wireless communications device is traveling a speed exceeding a first predetermined threshold but less than a second predetermined threshold, the device is presumed traveling in a motor vehicle. In order to inhibit operation of the wireless communication device when traveling, access to certain device functions or applications such as e-mail, text messaging, etc. are limited by requiring the user of the device to respond correctly to a randomly generated visual challenge, such as, for example, a CAPTCHA (in which a user is prompted to recognize the characters in a visually distorted string of text). This visual challenge presents a sufficient obstacle that the user will be less likely to use the wireless communications device for e-mailing or texting while operating a motor vehicle.
I US Patent application 2011/0092159 named Disabling of Services on A Communications Device was submitted by Park et al. in 2011. It provides a method, a system, and a computer program product for operating a communication device. A location information of a communication device is received. Based on the location information of the communication device, it is determined whether the communication device and another communication device are co-located. Based on the determination, operation of the communication device is controlled.
J Another US Patent application 2007/0072616 called Preventing Cellphone Usage When Driving was provided by Irani in 2007. It demonstrates a method for preventing cellular phone usage while driving. In one embodiment a GPS system incorporated into the workings of the cellular phone is used to detect that the phone is in motion, and that the rate of movement exceeds some preset value indicating that the phone is in a moving vehicle. Having detected motion the phone will deliver a number of options ranging from complete shutdown until motion stops, to use only for emergency purposes, to only limited use, or to complete use by interjecting a preset PIN or other such password which will allow the cellular phone user to override the phone shutdown mechanism. Other alternate means for detecting motion include triangulation between numerous towers, to signal strength variation from a single tower, to signals generated by miniature accelerometers and velocimeters imbedded in the phone specifically for detecting rate of movement.
   As can be observed, none of the prior art has anticipated or caused one skilled in the art of devices and systems to disable a driver from texting and being distracted during driving a vehicle to see this invention by Patrick Freeman as obvious to a person skilled in the ordinary art of the industry. The system and simple device using an electronic block or the ECM to temporarily disable texting and other distracting applications of a cell phone is a quick and simple method to make the use of cell phone and driving vehicles safer for the occupants.

### SUMMARY OF THE INVENTION

This invention is a device and system to disable a driver from texting and being distracted during driving a vehicle. Taught here are the ways a system can physically deter the use of a telephone while driving the vehicle.

The preferred embodiment of a device and system to disable a driver from texting and being distracted during driving a vehicle is comprised of: (a) a blocking signal component from an ECM of a vehicle engine or a discrete electronic device to notify the cellphone application that the vehicle engine is functioning and operation movement is occurring or is imminent; (b) at least one blocking application that signals the cellphone to block all incoming and outgoing communication signals to a set of cellphone applications and functions; (c) a set of only emergency other applications and functions desired to be available for usage for a period of time; (d) a means of communicating in the blocking application to the applications and functions which are to be temporarily disabled and blocked from usage; and (e) a means of clearing or re-enabling the applications and functions which are to be temporarily disabled and blocked from usage wherein the cellphone is temporarily disabled as to certain applications and function and wherein the drive of a vehicle is not distracted or tempted to use the cellphone while operating the vehicle.

The newly invented device and system to disable a driver from texting and being distracted during driving a vehicle for various applications may be manufactured at low volumes by very simple means and in high volume production by more complex and controlled systems.

### OBJECTS AND ADVANTAGES

There are several objects and advantages of the device and system to disable a driver from texting and being distracted during driving a vehicle. There are currently no known devices or systems that are as effective at providing the objects of this invention.

A device and system to disable a driver from texting and being distracted during driving a vehicle has various advantages and benefits:

| Item | Advantages |
|---|---|
| 1 | Easy to install as compared to other devices |
| 2 | Most components are available and tested |
| 3 | Universal designs for attachments to fit different |
| | telephone cell phones |
| 4 | May be integrally adapted with vehicle computer |
| | control modules |
| 5 | May be separately adapted with add-on and separate |
| | signal devices |
| 6 | Does not interfere with other passenger devices |
| 7 | Able to receive emergency calls and use 911 |
| | features |

Finally, other advantages and additional features of the present device and system to disable a driver from texting and being distracted during driving a vehicle will be more apparent from the accompanying drawings and from the full description of the device. For one skilled in the art of communication and cellphone/electronic devices it is readily understood that the features shown in the examples with this product are readily adapted to other types of electronic and cellphone disabling systems and devices.

### DESCRIPTION OF THE DRAWINGS—FIGURES

The accompanying drawings, which are incorporated in and constitute a part of this specification, illustrate an embodiment of the device and system to disable a driver from texting and being distracted during driving a vehicle that is preferred. The drawings together with the summary description given above and a detailed description given below serve to explain the principles of the special cellphone disabling device. It is understood, however, that the special cellphone disabling device is not limited to only the precise arrangements and instrumentalities shown.

FIGS. 1A through 1G are sketches of the general use and mis-use of cellphones in vehicles with distractions to safe driving.

FIGS. 2A and 2B are sketches of the general signals coming from cell towers to cellphones in vehicles as well as interrupted signals to cellphones noted.

FIGS. 3A through 3D are sketches of an automatic interruption signal from the vehicle ECM or an auxiliary device to a disabling application loaded on a cellphone.

FIG. 4 is a step-by-step process for disabling driver usage of the cellphone and messaging application while the vehicle is in use.

FIG. 5 is a sample list of applications disabled and enabled while the device and system to disable a driver from texting and being distracted during driving a vehicle is activated.

FIG. 6A through 6C and FIGS. 7A through 7C are sketches of prior art.

### DESCRIPTION OF THE DRAWINGS—REFERENCE NUMERALS

The following list refers to the drawings:

TABLE B
Reference numbers

| Ref # | Description |
|---|---|
| 30 | device and system 30 to disable a driver from |
| | texting and being distracted during driving a |
| | vehicle |
| 31 | cellphone signal tower 31 |
| 32 | signal 32 from tower 31 of telephone |
| | communications and internet signals with |
| | various messaging and video data |
| 32A | discrete signal 32A from tower 31 of telephone |
| | 40, 42 |
| 33 | blockage method 33 signal to cell phone from |
| | ECM (Electronic Engine Control Module) 34 or |
| | discrete electronic blocking apparatus 36 |
| | placed in vehicle interior 37. Signal may be |
| | (Wi-Fi, Bluetooth, hot spot, satellite, radar, |
| | and others etc.) |
| 34 | ECM (Electronic Engine Control Module) 34 with |
| | blockage signal 33 |
| 35 | method of operation 35 of the device and system |
| | 30 to disable a driver from texting 49 and |
| | being distracted 46 during driving |
| 36 | discrete electronic blocking apparatus 36 |
| | placed into the dash panel, mirror support |
| | structure, and dashboard of the vehicle 37- |
| | emits blockage method 33 signal to cell phone |
| 37 | vehicle and vehicle interior 37 with dash |
| | panel, mirror support structure, and dashboard |
| 38 | typical engine block 38 with various components |
| | including ECM 34 |
| 39 | blocking application 39 signaled from the ECM |
| | 34 or discrete blocking device 36 and signaled |
| | to the cell phone 40, 42 to disable or switch |
| | off |
| 40 | smart cellphone 40 with blocking application 39 |
| 41 | tablet or laptop 41 |
| 42 | older version cellphone 42 |
| 45 | no texting signage 45 to outlaw or dissuade |
| | usage while driving |
| 46 | crisis of distractions and current dangers |
| | missed 46 while texting 49 |
| 47 | talking or telephoning 47 on a cellphone 40, 42 |
| | while driving |
| 48 | operating a tablet or laptop 48 and being |
| | distracted during driving |
| 49 | texting 49 on a cellphone 40, 42 |
| 50 | chart 50 of examples of blocked and allowed |
| | applications and functions on the cellphone 40, |
| | 42 |
| 52 | examples of blocked 52 applications and |
| | functions on the cellphone 40, 42 |
| 54 | examples of permitted and available 54 |
| | applications and functions on the cellphone 40, |
| | 42 |
| 60 | user 60 |
| 70 | prior Art 70 Pat. No. 8,217,800 |
| 71 | prior Art 71 Pat. No. 8,380,176 |
| 72 | prior Art 72 Pat. No. 9,462,110 |
| 73 | prior Art 73 Pat. No. 9,661,127 |
| 74 | prior Art 74 Pat. No. 9,386,447 |
| 75 | prior Art 75 Pat. No. 8,295,854 |

### DETAILED DESCRIPTION OF PREFERRED EMBODIMENT

This invention relates to a device and system to disable a driver from texting and being distracted during driving a vehicle. This invention relates to the field of cellular phones and cellular communications technology including text messaging, emailing, and voice communications technology, GPS technology, related computer systems and software, and vehicular transportation modalities. Particularly this device or system is related to products and manners to prevent distraction while driving a vehicle. The subject matter described herein generally relates to restricting services of a communication device. Some implementations of the subject matter relate to selectively disabling services provided by an individual's communication device based on a location of the communication device or other determination that the individual is engaged in an activity for which the distractions of the communication device usage can be dangerous or should otherwise be restricted. The present disclosure relates generally to wireless communications devices and, in particular, to techniques for disabling ALL EXCEPT certain device functionalities (Emergency 911 Calls) based on motion of the device.

This invention further relates in general to improving the safety of drivers as it relates to the use of cellular phones and other portable electronic communication devices. This invention relates to increasing the safety and wellbeing of a cellular phone user if he should be simultaneously driving a vehicle. Specifically, this invention relates to a means for disabling a driver's cellphone so that when a cellphone is in motion, except for specific situations, the availability of the cellphone for communication purposes is curtailed to allow the cellphone owner to remain totally focused on the control of the moving vehicle. The disclosure relates to inhibiting many of the functions of a multi-function portable personal communications device and inhibiting one or more functions of a cellular telephone handset when the handset is moved at an average velocity greater than a predetermined value. The inhibited functions generally relate to restricting the use of a mobile communication device by an operator of a vehicle, and in particular, to restricting operator use of mobile services such as texting, watching videos, and playing games while, e.g., driving an automobile.

The advantages for the device and system 30 to disable a driver from texting and being distracted during driving a vehicle or special cellphone disabling device 30 are listed above in the introduction. Succinctly the benefits are that the device:
Easy to install as compared to other devices
Most components are available and tested
Universal designs for attachments to fit different telephone cell phones
May be integrally adapted with vehicle computer control modules
May be separately adapted with add-on and separate signal devices
Does not interfere with other passenger devices
Able to receive emergency calls and use 911 features

The preferred embodiment of a device and system to disable a driver from texting and being distracted during driving a vehicle is comprised of: (a) a blocking signal component from an ECM of a vehicle engine or a discrete electronic device to notify the cellphone application that the vehicle engine is functioning and operation movement is occurring or is imminent; (b) at least one blocking application that signals the cellphone to block all incoming and outgoing communication signals to a set of cellphone applications and functions; (c) a set of only emergency applications and functions desired to be available for usage for a period of time; (d) a means of communicating in the blocking application to the applications and functions which are to be temporarily disabled and blocked from usage; and (e) a means of clearing or re-enabling the applications and functions which are to be temporarily disabled and blocked from usage

wherein the cellphone is temporarily disabled as to certain applications and function and wherein the drive of a vehicle is not distracted or tempted to use the cellphone while operating the vehicle.

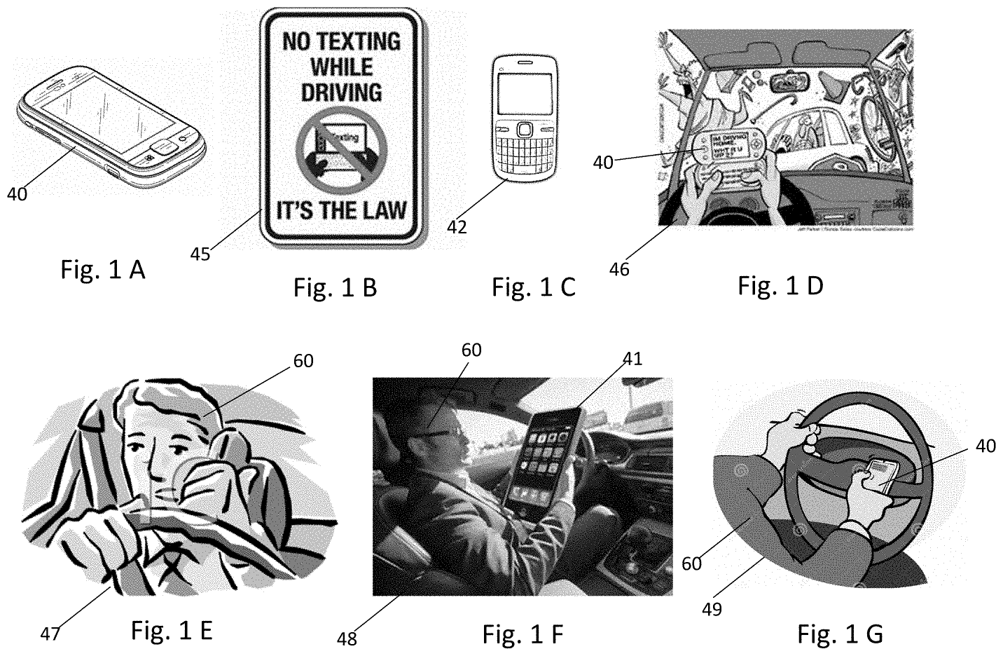

There is shown in drawings FIGS. 1-7 a complete description and operative embodiment of the device and system to disable a driver from texting and being distracted during driving a vehicle. In the drawings and illustrations, one notes well that the FIGS. 1-7 demonstrate the general configuration and use of this product and system. The various example uses are in the operation and use section, below.

FIGS. 1A through 1G are sketches of the general use and mis-use of cellphones in vehicles with distractions to safe driving. In these sketches, the “problems” with distracted drivers are depicted. Shown in these sketches are a smart cellphone 40 with blocking application 39 signaled from the ECM 34 or discrete blocking device 36 and signaled to the cell phone 40, 42 to disable or switch off; a tablet or laptop 41; an older version cellphone 42; a typical no texting signage 45 to outlaw or dissuade usage while driving; a sketch of a crisis of distractions and current dangers missed 46 while texting 49;

a sketch talking or telephoning 47 on a cellphone 40, 42 while driving; operating a tablet or laptop 48 and being distracted during driving; a scene texting 49 on a cellphone 40, 42; and a user 60.

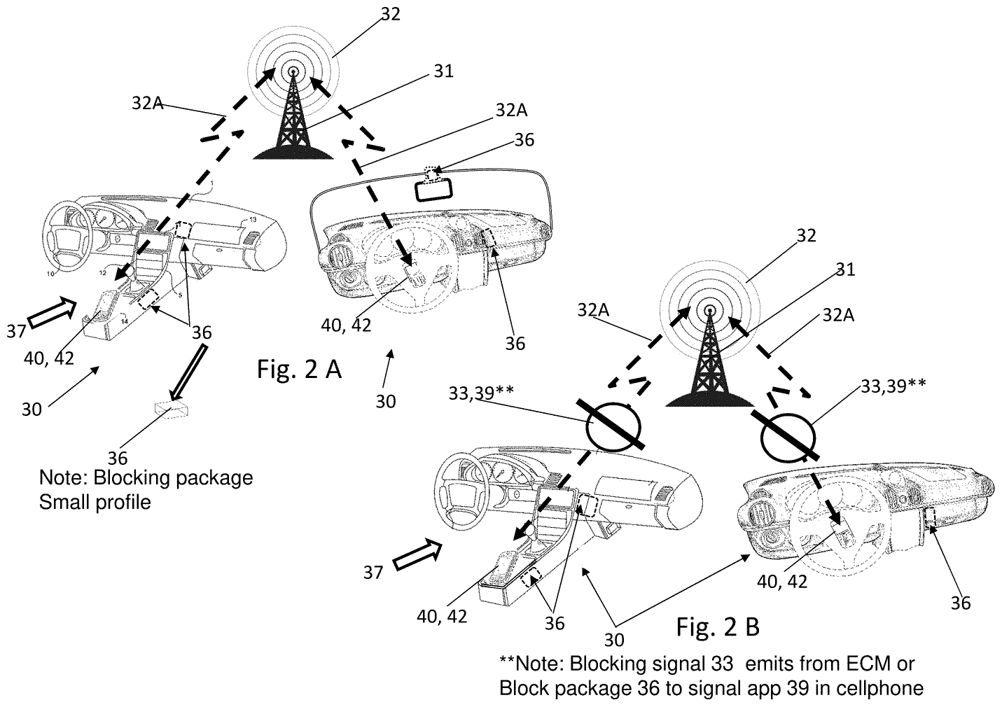

FIGS. 2A and 2B are sketches of the general signals coming from cell towers 31 to cellphones 40, 42 in vehicles 37 as well as interrupted signals to cellphones noted. These sketches include: a device and system 30 to disable a driver from texting and being distracted during driving a vehicle; a cellphone signal tower 31; a signal 32 from tower 31 of telephone communications and internet signals with various messaging and video data; a discrete signal 32A from tower 31 of telephone 40, 42; a blockage method 33 signal to cell phone from ECM (Electronic Engine Control Module) 34 or discrete electronic blocking apparatus 36 placed in the dash panel, mirror support structure, or dashboard of the vehicle interior 37—emits blockage method 33 signal to cell phone [Signal may be (Wi-Fi, Bluetooth, hot spot, satellite, radar, and others, etc.]; a vehicle interior 37 with dash panel and dash board; a typical engine block 38 with various components including ECM 34; a blocking application 39 signaled from the ECM 34 or discrete blocking device 36 and signaled to the cell phone 40, 42 to disable or switch off; a smart cellphone 40 with blocking application 39; and an older version cellphone 42. One notes that the Blocking package 36 is of a small profile.

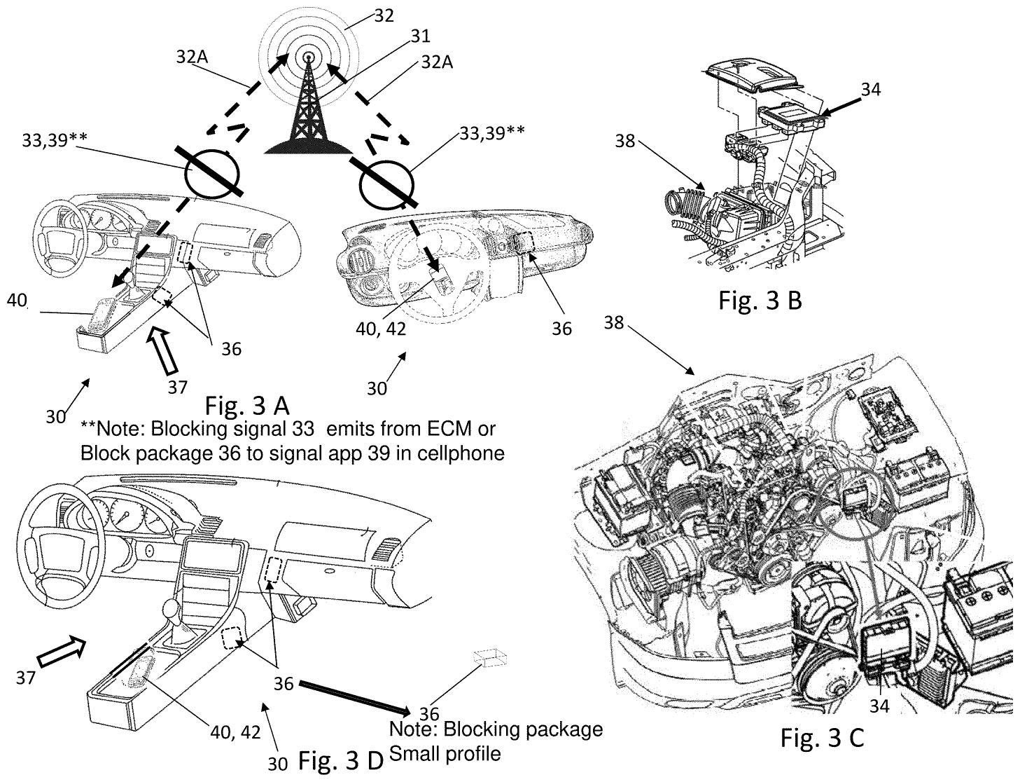

FIGS. 3A through 3D are sketches of an automatic interruption signal 33 from the vehicle ECM 34 or an auxiliary device 36 to a disabling application 39 loaded on a cellphone 40, 42. These views show the following: a device and system 30 to disable a driver from texting and being distracted during driving a vehicle; a cellphone signal tower 31; a signal 32 from tower 31 of telephone communications and internet signals with various messaging and video data; a discrete signal 32A from tower 31 of telephone 40, 42; a blockage method 33 signal to cell phone from ECM (Electronic Engine Control Module) 34 or discrete electronic blocking apparatus 36 placed in the dash panel, mirror support structure, or dashboard of the vehicle interior 37—emits blockage method 33 signal to cell phone [Signal may be Wi-Fi, Bluetooth, hot spot, satellite, radar and others, etc.]; an ECM (Electronic Engine Control Module) 34; a discrete electronic blocking apparatus 36 placed in the dash panel, mirror support structure, or dashboard of the vehicle 37; a vehicle interior 37 with dash panel and dash board; a typical engine block 38 with various components including ECM 34; a blocking application 39 signaled from the ECM 34 or discrete blocking device 36 and signaled to the cell phone 40, 42 to disable or switch off; a smart cellphone 40 with blocking application 39; and an older version cellphone 42. One notes that the Blocking package 36 is of a small profile.

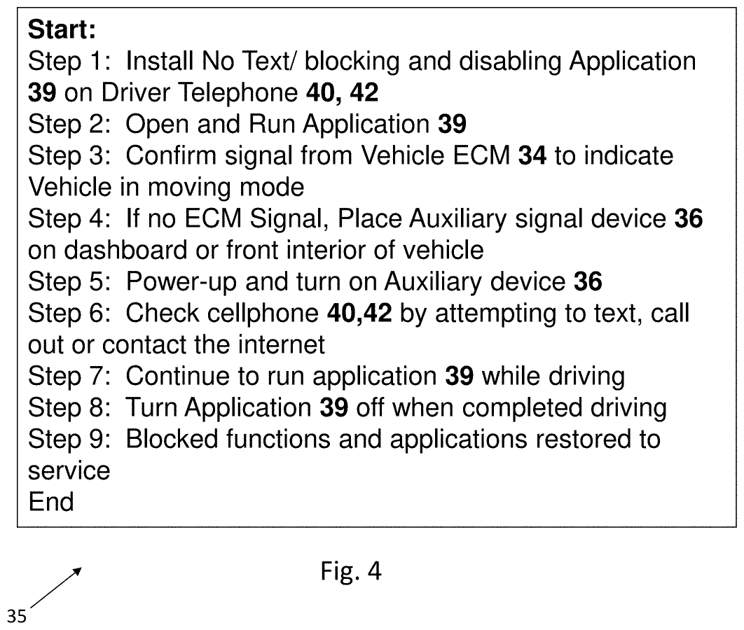

FIG. 4 is a step-by-step process for disabling driver usage of the cellphone and messaging application while the vehicle is in use. It is described below in the Operation section.

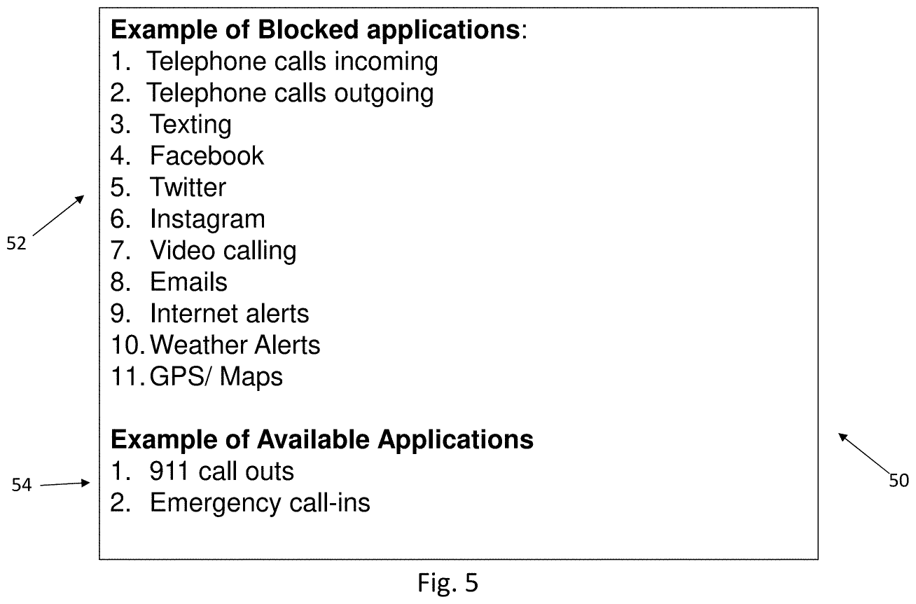

FIG. 5 is a sample list 50 of applications disabled 52 and enabled 54 while the device and system 30 to disable a driver from texting and being distracted during driving a vehicle is activated. Shown here are a chart 50 of examples of blocked and allowed applications and functions on the cellphone 40, 42; a set of examples of blocked 52 applications and functions on the cellphone 40, 42; and a set of examples of permitted and available 54 applications and functions on the cellphone 40, 42. Here also are the examples of applications and functions blocked including (but not limited to):
1) Telephone calls incoming
2) Telephone calls outgoing
3) Texting
4) Facebook
5) Twitter
6) Instagram
7) Video calling
10) Weather Alerts
11) GPS/Maps
   Finally, also shown are the examples of very few applications and functions not blocked including (but not limited to):
a) 911 call outs
b) Emergency call-ins

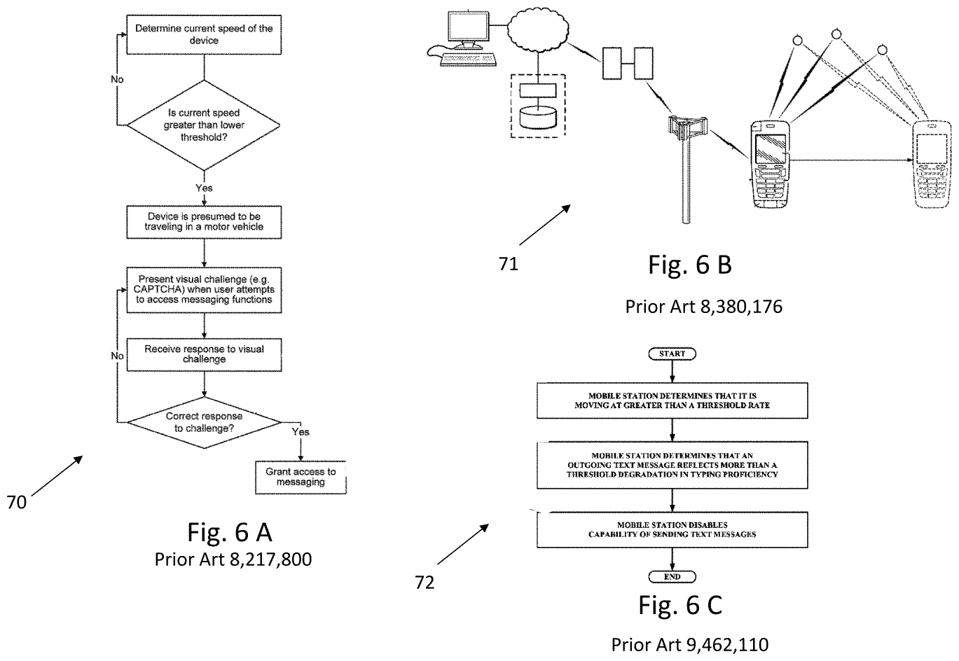

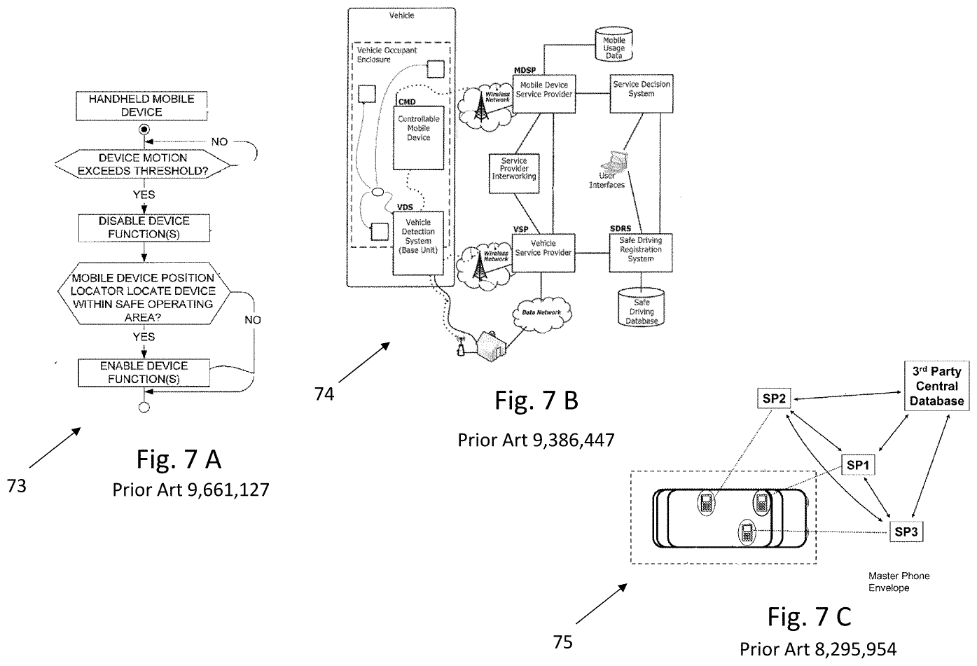

FIG. 6A through 6C and FIGS. 7A through 7C are sketches of prior art. Here former patents and applications for various disabling systems and devices are shown. These include: a prior Art 70 U.S. Pat. No. 8,217,800 entitled Motion Based Disabling Of Messaging On A Wireless Communications Device; a prior Art 71 U.S. Pat. No. 8,380,176 entitled Method Of Inhibiting Functions Of A Mobile Communications Device; a prior Art 72 U.S. Pat. No. 9,462,110 entitled Methods And Systems For Disabling One Or More Text Messaging Features While Driving; a prior Art 73 U.S. Pat. No. 9,661,127 entitled Locking-Out A Driver Handheld Mobile Device During Driving Of A Vehicle For Texting And Browsing; a prior Art 74 U.S. Pat. No. 9,386,447 entitled Method And System For Controlling A Mobile Communication Device; and a prior Art 75 U.S. Pat. No. 8,295,854 entitled System For Preventing Text Messaging While Driving. As can be seen, the device and system to disable a driver from texting and being distracted during driving a vehicle is a unique combination of components and system as described herein.

The details mentioned here are exemplary and not limiting. Other specific components and manners specific to describing a device and system to disable a driver from texting and being distracted during driving a vehicle may be added as a person having ordinary skill in the field of the disabling devices for electronic systems and cellphones and their uses well appreciates.

### OPERATION OF THE PREFERRED EMBODIMENT

The device and system to disable a driver from texting and being distracted during driving a vehicle has been described in the above embodiment. The manner of how the device operates is described below. One notes well that the description above and the operation described here must be taken together to fully illustrate the concept of the device and system to disable a driver from texting and being distracted during driving a vehicle. The preferred embodiment of a device and system to disable a driver from texting and being distracted during driving a vehicle is comprised of: (a) a blocking signal component from an ECM of a vehicle engine or a discrete electronic device to notify the cellphone application that the vehicle engine is functioning and operation movement is occurring or is imminent; (b) at least one blocking application that signals the cellphone to block all incoming and outgoing communication signals to a set of cellphone applications and functions; (c) a set of only emergency applications and functions desired to be available for usage for a period of time; (d) a means of communicating in the blocking application to the applications and functions which are to be temporarily disabled and blocked from usage; and (e) a means of clearing or re-enabling the applications and functions which are to be temporarily disabled and blocked from usage wherein the cellphone is temporarily disabled as to certain applications and function and wherein the drive of a vehicle is not distracted or tempted to use the cellphone while operating the vehicle.

FIG. 4 describes a step-by-step process for disabling driver 60 usage of the cellphone 40, 42 and messaging application while the vehicle 37 is in use. The essential operation is:
Start:
Step 1: Install a No Text/blocking and disabling Application (39) on the cell phone (40,42) of the user/driver;
Step 2: Open and Run Application (39);
Step 3: Confirm signal from Vehicle blocking component (34,36) which indicates a movement of the vehicle is imminent;
   in moving mode
Step 4: Power-up and turn on blocking component (34, 36);
Step 5: Check cellphone 40,42 by attempting to text, call out or contact the internet;
Step 6: Continue to run application (39) while driving;
Step 7: Turn Application (39) off when completed driving;
Step 8: Check to see if Blocked functions and applications are restored to service;
Step 9: Repeat at net usage of vehicle by user/driver
   wherein the method with the cellphone temporarily disables certain applications and function and wherein by using the method, the user/driver of the vehicle is not distracted and tempted to use the cellphone while operating the vehicle.

Many uses are anticipated for the device and system to disable a driver from texting and being distracted during driving a vehicle. Some examples, and not limitations, are shown in the following Table.

| ITEM | DESCRIPTION |
|---|---|
| 1 | Smart cellphones |
| 2 | flip top/standard cellphones |
| 3 | Electronic tablets with messaging |
| | and even telephone options |
| 4 | Laptop computers with messaging |
| | and even telephone options |

With this description it is to be understood that the device and system to disable a driver from texting and being distracted during driving a vehicle is not to be limited to only the disclosed embodiment of product. The features of the special cellphone disabling device and system 30 are intended to cover various modifications and equivalent arrangements included within the spirit and scope of the description.

While certain novel features of this invention have been shown and described and are pointed out in the annexed claims, this is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. Various features and aspects of the disclosed embodiments can be combined with or substituted for one another to form varying modes of the disclosed inventions. Thus, it is intended that the scope of at least some of the present inventions herein disclosed should not be limited by the disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A system to disable a cellphone of a user/driver from texting and from being distracted during a driving operation of a vehicle comprised of:
(a) a blocking signal component on the vehicle used to notify a cellphone application that an engine of the vehicle functioning and that movement is imminent;
(b) a blocking application (39) loaded on the cellphone of a user that can block on the cell phone all incoming and outgoing communication signals to a set of cellphone applications and functions;
(c) at least one blockage signal (33) emitted from the blocking signal component that is used to signal the blocking application (39) of the cellphone (40,42);
(d) a set of emergency applications and functions desired to be enabled and available for usage for a period of time;
(e) a means of internal to the cellphone and blocking application for communicating to the applications and functions which are to be temporarily disabled and blocked from usage; and
(e) a means of clearing and re-enabling the applications and functions which were temporarily disabled and blocked to return to normal usage
wherein the cellphone is temporarily disabled as to certain applications and function and wherein the user/driver of the vehicle is not distracted and tempted to use the cellphone while operating the vehicle.

2. A system to disable a cellphone of a user/driver from texting and from being distracted during a driving operation in claim 1 wherein blocking signal component is selected from the group consisting of a built-in feature of the ECM and discrete electronic blocking apparatus (36).

3. A system to disable a cellphone of a user/driver from texting and from being distracted during a driving operation in claim 2 wherein the discrete electronic blocking apparatus (36) is mounted in a place selected from the group consisting of a dash panel, a mirror support structure, and a dashboard of the vehicle.

4. A system to disable a cellphone of a user/driver from texting and from being distracted during a driving operation in claim 1 wherein the blockage signal (33) is selected from the group consisting of Wi-Fi, Bluetooth, hot spot, satellite and radar.

5. A system to disable a cellphone of a user/driver from texting and from being distracted during a driving operation in claim 1 wherein the applications and functions temporarily disabled are selected from the group consisting of telephone calls incoming, telephone calls outgoing, texting, Facebook, Twitter, Instagram, video calling, E-mails, Internet alerts, weather alerts, and GPS/Maps

6. A system to disable a cellphone of a user/driver from texting and from being distracted during a driving operation in claim 1 wherein the applications and functions mot temporarily disabled are selected from the group consisting of 911 call outs and emergency call-ins.

7. A method to disable a cellphone of a user/driver from texting and from being distracted during a driving operation of a vehicle comprised of:
Step 1: Install a No Text/blocking and disabling Application (39) on the cell phone (40,42) of the user/driver;
Step 2: Open and Run Application (39);
Step 3: Confirm signal from Vehicle blocking component (34,36) which indicates a movement of the vehicle is imminent;
in moving mode
Step 4: Power-up and turn on blocking component (34, 36);
Step 5: Check cellphone (40,42) by attempting to text, call out or contact the internet;
Step 6: Continue to run application (39) while driving;
Step 7: Turn Application (39) off when completed driving;
Step 8: Check to see if Blocked functions and applications are restored to service;
Step 9: Repeat at net usage of vehicle by user/driver
wherein the method with the cellphone temporarily disables certain applications and function and wherein by using the method, the user/driver of the vehicle is not distracted and tempted to use the cellphone while operating the vehicle.

8. A method to disable a cellphone of a user/driver from texting and from being distracted during a driving operation in claim 7 wherein the blocking signal component is selected from the group consisting of a built-in feature of the ECM and discrete electronic blocking apparatus (36).

9. A method to disable a cellphone of a user/driver from texting and from being distracted during a driving operation in claim 8 wherein the discrete electronic blocking apparatus (36) is mounted in a place selected from the group consisting of a dash panel, a mirror support structure, and a dashboard of the vehicle.

10. A method to disable a cellphone of a user/driver from texting and from being distracted during a driving operation in claim 7 wherein the blockage signal (33) is selected from the group consisting of Wi-Fi, Bluetooth, hot spot, satellite and radar.

11. A method to disable a cellphone of a user/driver from texting and from being distracted during a driving operation in claim 1 wherein the applications and functions temporarily disabled are selected from the group consisting of telephone calls incoming, telephone calls outgoing, texting, Facebook, Twitter, Instagram, video calling, E-mails, Internet alerts, weather alerts, and GPS/Maps

12. A method to disable a cellphone of a user/driver from texting and from being distracted during a driving operation in claim 1 wherein the applications and functions mot temporarily disabled are selected from the group consisting of 911 call outs and emergency call-ins.
